(19) United States
(12) Patent Application Publication
(10) Pub. No.: US 2013/0258693 A1
(43) Pub. Date: Oct. 3, 2013

(54) LIGHT SOURCE DEVICE FOR VEHICLE

(71) Applicants: Yoshiyuki Hatakeyama, Fuji-shi (JP); Shinya Kawamata, Mishima-shi (JP); Sei Iguchi, Okazaki-shi (JP)

(72) Inventors: Yoshiyuki Hatakeyama, Fuji-shi (JP); Shinya Kawamata, Mishima-shi (JP); Sei Iguchi, Okazaki-shi (JP)

(73) Assignees: DENSO CORPORATION, Kariya-city, Aichi-Pref (JP); TOYOTA JIDOSHA KABUSHIKI KAISHA, Toyota-shi, Aichi-ken (JP)

(21) Appl. No.: 13/991,765

(22) PCT Filed: Dec. 12, 2011
(86) PCT No.: PCT/IB2011/002992

§ 371 Date: Jun. 5, 2013

(30) Foreign Application Priority Data
Dec. 15, 2010 (JP) 2010-279214

(51) Int. Cl. F21S 8/10

(52) U.S. Cl. CPC F21S 48/00
USPC 362/509; 362/543

(57) ABSTRACT

The driver side of a light source panel is curved in a concave configuration which conforms with the curvature (curve) of the cross-section of the area of a front windshield glass, in which a virtual image is displayed. Individual light sources are arranged in the light source panel in a curved configuration which conforms with the curvature (curve) of the cross-section of the area of the front windshield glass, in which the virtual image is displayed.

### BACKGROUND OF THE INVENTION

1. Field of the Invention

The present invention relates to a light source device for a vehicle.

2. Description of the Related Art

Each of Japanese Patent Application Publication No. 2008-13163 (JP-A-2008-13163) and Japanese Patent Application Publication No. 2008-189201 (JP-A-2008-189201) discloses a visual recognition assistance device for a vehicle, in which a plurality of point light sources are linearly arranged in the vicinity of a boundary between an instrument panel and a windshield, and which linearly projects a virtual image on the windshield.

Other related art documents include Japanese Patent Application Publication No. 2008-197403 (JP-A-2008-197403), Japanese Patent Application Publication No. 2002-287076 (JP-A-2002-287076), Japanese Patent Application Publication No. 2002-274216 (JP-A-2002-274216), and Japanese Patent Application Publication No. 2003-54334 (JP-A-2003-54334). JP-A-2008-197403 discloses a headup display device in which the inclination angle of a reflection plate is adjustable. JP-A-2002-287076 discloses a headup display in which a reflection plate is inclined. Each of JP-A-2002-274216 and JP-A-2003-54334 discloses a display device for a vehicle, in which light guide pipes are arranged along a frame of a windshield.

However, according to JP-A-2008-13163 and JP-A-2008-189201, cumbersome adjustment of the light emission angle of the point light sources is required to linearly project the virtual image on the windshield. In addition, there is a possibility that ambient light may be reflected toward a driver. That is, according to JP-A-2008-13163 and JP-A-2008-189201, there is room for improvement in information transmission efficiency, and a technique for improving the information transmission efficiency.

### SUMMARY OF THE INVENTION

The present invention provides a light source device for a vehicle which can improve the visibility of light without cumbersome adjustment.

A first aspect of the present invention relates to a light source device for a vehicle, which is installed in an instrument panel, and which includes a plurality of light sources, wherein the plurality of light sources are arranged in accordance with a curvature of an area on a windshield, to which light from the plurality of light sources is emitted. And the other aspect of the present invention relates to a light source device for a vehicle, which is installed in an instrument panel, and which includes a light source and a light emission plate, wherein the light emission plate is installed such that a light-emitting face of the light emission plate is inclined toward a driver.

According to the invention, the plurality of light sources are arranged in accordance with the curvature of the area on the windshield, to which light from the plurality of light sources is emitted. This arrangement makes the light from the light sources more visible to the driver and leads to improvement in information transmission efficiency without cumbersome adjustment.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a view that illustrates an example of the installation position of a light source panel 10;

FIG. 2 is a view that illustrates an example of the installation position of the light source panel 10;

FIG. 3 is a view that illustrates the definition of an eye point 30;

FIG. 4 is a view that illustrates an example of the installation position of the light source panel 10;

FIG. 5 is a view that illustrates an example of the structure of the light source panel 10;

FIG. 6 is a view that illustrates an example of the structure of the light source panel 10;

FIG. 7 is a view that illustrates an example of the structure of the light source panel 10;

FIG. 8 is a view that illustrates an example of the installation position of the light source panel 10; and

FIG. 9 is a view that illustrates an example of the installation position of the light source panel 10.

### DETAILED DESCRIPTION OF THE PREFERRED EMBODIMENTS

Description is hereinafter made of an embodiment of a light source device for a vehicle according to the present invention with reference to the drawings. It should be noted that the present invention is not limited by the embodiment.

In the following, a case where a light source panel according to this embodiment is incorporated in a right-hand drive vehicle and is used in an information transmission system for a vehicle that conveys information to the driver by reflecting a virtual image that is formed by light on the windshield glass is described as an example.

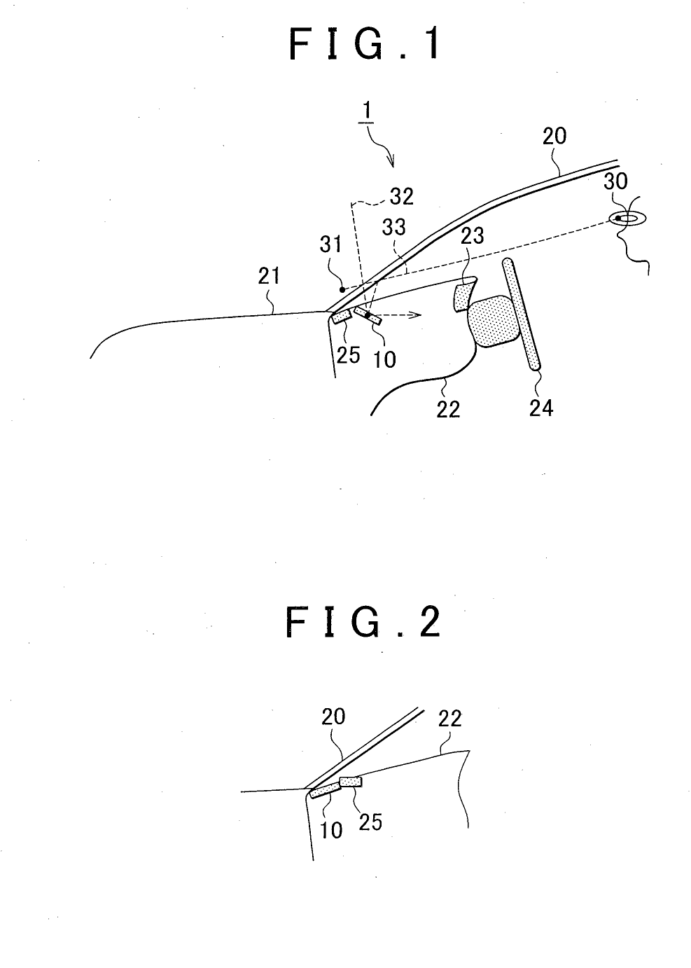

FIGS. 1 and 2 are views, each of which illustrates an example of the installation position of a light source panel. In FIGS. 1 and 2, reference numeral 1 indicates a vehicle, reference numeral 10 indicates a light source panel, reference numeral 20 indicates a front windshield glass, reference numeral 21 indicates a bonnet, reference numeral 22 indicates an instrument panel, reference numeral 23 indicates a meter panel, reference numeral 24 indicates a steering wheel, reference numeral 25 indicates a defroster outlet, reference numeral 30 indicates the driver's eye point, reference numeral 31 indicates a virtual image that is formed by the light from the light source panel 10, reference numeral 32 indicates a light path of ambient light, and reference numeral 33 indicates a light path of the light from the light source panel 10. As shown in FIG. 1, the light source panel 10 is installed in the instrument panel 22, especially, in such a position that the driver can recognize the virtual image 31 in the lowermost area of his or her peripheral visual field. For example, the light source panel 10 may be located on the front windshield glass 20 side with respect to the meter panel 23 (in other words, on the far side of the instrument panel 22 as viewed from the eye point 30). For example, the light source panel 10 may be located on either in front of (refer to FIG. 1) or behind (refer to FIG. 2) the defroster outlet 25 as viewed from the eye point 30.

As shown in FIG. 1, the light source panel 10 is installed in the instrument panel 22 in such a manner that the ambient light 32 does not reach the eye point 30. For example, the light source panel 10 may be located below the surface of the instrument panel 22 (in other words, in the instrument panel 22) with its light-emitting face (light-reflecting face) inclined toward the driver. For example, the light source panel 10 may be embedded in the instrument panel 22. This arrangement makes a real image, in other words, the light source, invisible to the driver and from other vehicles.

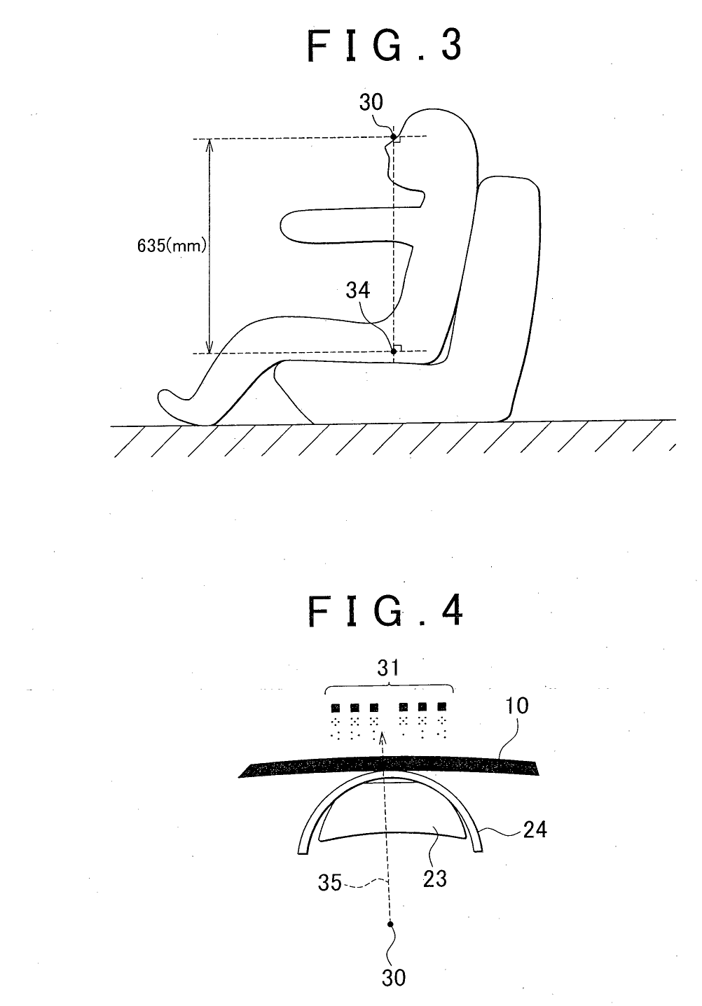

Here, as shown in FIG. 3, the eye point 30 is a point at a height of 635 (mm) vertically above a seating reference point 34, the location of the hip joint of the mannequin seated in the driver's seat based on ISO 6549-1980 (refer to Notification of Details of Safety Standards for Road Transport Vehicles [2005.11.09], Appendix 81 (Technical Standards for Left Front Side-View Mirror), which is disclosed in “http://wvvw.mlit.go.jp/jidosha/kijyun/saimokubetten/saibet_{—}081_{—}00.pdf”).

FIG. 4 is a view that illustrates another example of the installation position of the light source panel. In FIG. 4, reference numeral 35 indicates the driver's line of sight. For example, the light source panel 10 is located generally in front of the driver on the instrument panel 22. The light source panel 10 has light sources 10a that are arranged in a curved configuration so that the virtual image 31 can be horizontal as viewed by the driver (from the eye point 30). Here, one example of the structure of the light source panel 10 is described with reference to FIGS. 5, 6 and 7.

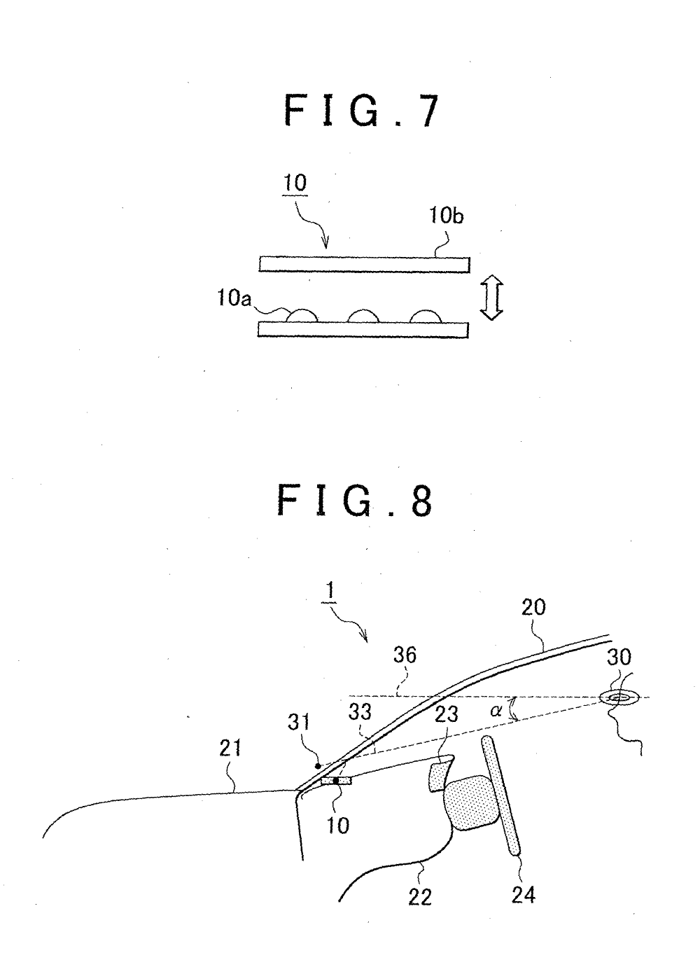

As shown in FIG. 5, the light source panel 10 has a plurality of light sources 10a (such as LEDs or bulbs) arranged in an array of rows and columns. In addition, as shown in FIG. 7, the light source panel 10 has a light emission plate 10b that is located at a given distance from the light sources 10a to emit the light from the light sources 10a to the outside.

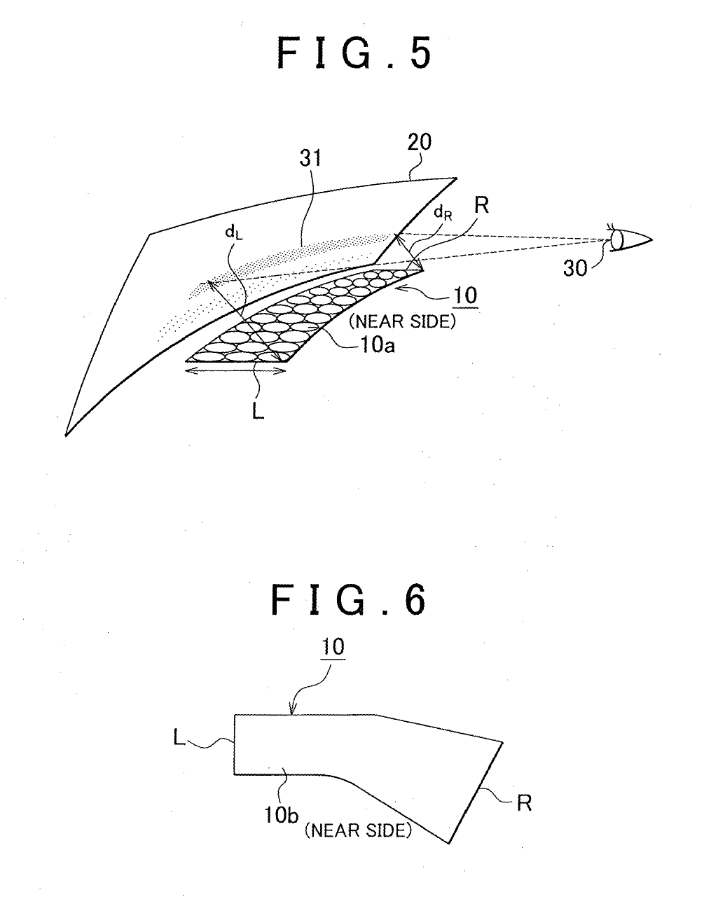

As shown in FIG. 5, the near side (the driver side) of the light source panel 10 is curved in a concave configuration which conforms with the curvature (curve) of the cross-section of the area of the front windshield glass 20 in which the virtual image 31 is displayed, the cross-section being taken along the horizontal direction. The individual light sources 10a are arranged in the light source panel 10 in a curved configuration which conforms with the curvature (curve) of the cross-section of the area of the front windshield glass 20 in which the virtual image 31 is displayed. The light source panel 10 is shaped such that a distance dL is greater than a distance dR when it is installed (refer to FIG. 5). The light source panel 10 has a minimum length (width) at its left end L as viewed by the driver (from the eye point 30), gradually increases in length (width) toward its right end and has a maximum length (width) at its right end R (refer to FIG. 6). The shape of the light source panel 10 and the arrangement of the light sources 10a enable the virtual image 31 to be projected on the front windshield glass 20 horizontally as viewed by the driver. Here, the distance dL is the distance from the light source 10a which is located at the near left corner when the installed light source panel 10 is viewed by the driver (from the eye point 30) to the position on the front windshield glass 20 on which the light from the light source 10a is projected. The distance dR is the distance from the light source 10a which is located at the near right corner when the installed light source panel 10 is viewed by the driver (from the eye point 30) to the position on the front windshield glass 20 where the light from the light source 10a is reflected. In other words, the light sources 10a are arranged such that the distance dL is greater than the distance dR.

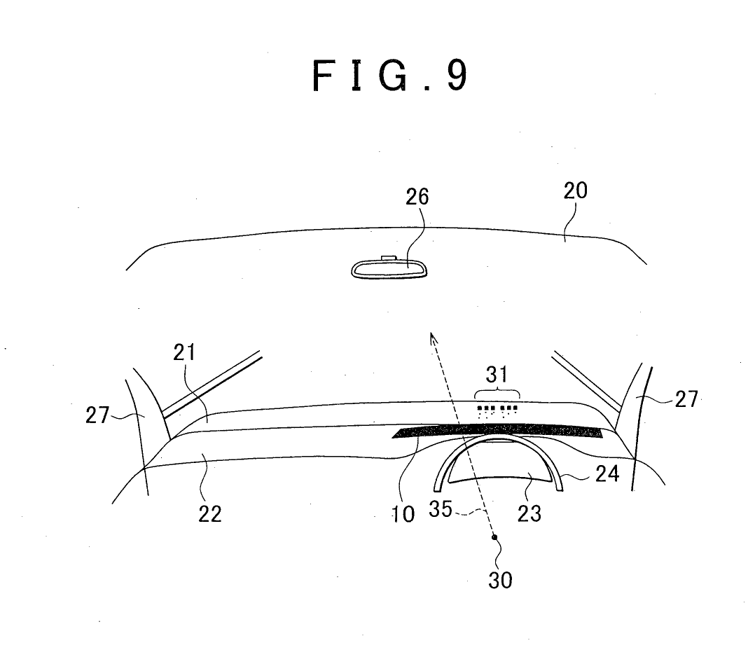

FIGS. 8 and 9 are views, each of which illustrates another example of the installation position of the light source panel. In FIG. 8, reference numeral 36 indicates a horizontal line that passes through the eye point 30. In FIG. 9, reference numeral 26 indicates a rear-view mirror, and reference numeral 27 indicates an A-pillar. The light source panel 10 is located in such a position that the virtual image 31 is seen by the driver at an angle of depression a of 5 degrees or less below the horizontal line 36. In addition, the light source panel 10 is located in such a position on the instrument panel 22 that some or entire portion of the virtual image 31 is seen against the bonnet 21 of the vehicle 1 as viewed from the eye point 30.

In the embodiment, the examples, in which the light source panel 10 is located in such a position that the virtual image 31 is seen by the driver at an angle of depression a of 5 degrees or less below the horizontal line 36, have been described. However, the invention is not limited to the examples. The light source panel 10 may be located in such a position on the instrument panel 22 that the virtual image 31 is projected in an area under the horizontal line 36 on the front windshield glass 20 as long as at least a portion of the virtual image 31 is seen against the bonnet 21 of the vehicle 1 as viewed from the eye point 30.

While an example in which the light source panel 10 is installed on the driver side in the instrumental panel in a right-hand drive vehicle is described in this embodiment, the present invention is not limited thereto and is applicable to a left-hand drive vehicle.

As has been described in detail in the foregoing, according to this embodiment, the light sources 10a are installed in the instrument panel 22 in accordance with the curvature of the area on the front windshield glass 20 to which the light from the light sources 10a is emitted. This enables the virtual image 31 to be projected linearly on the front windshield glass 20 without cumbersome adjustment of the light emission angle. In addition, the light source panel 10 is installed in the instrument panel 22 with the light-emitting face of its light emission plate 10b inclined toward the driver. This prevents ambient light from being reflected toward the driver. In other words, these arrangements make the light from the light sources 10a more visible to the driver and lead to improvement in information transmission efficiency without cumbersome adjustment.

According to this embodiment, the light from the light sources 10a is emitted to an area on the front windshield glass 20 where the virtual image 31 is seen against the bonnet 21 of the vehicle 1 as viewed from the eye point 30 (bonnet area). This eliminates the influence of changes in the background outside the vehicle and makes the light from light sources 10a more visible to the driver. In addition, the light from the light sources 10a is emitted to the area outside the bonnet area and under a line segment where a horizontal plane (the horizontal line 36) that passes through the eye point 30 and the front windshield glass 20 intersect. This enables the virtual image 31 to be projected in a position which does not interfere with the driver's line of sight. In other words, these arrangements improve the visibility of the light.

As described in the foregoing, the light source device for a vehicle according to the present invention is useful for automobile production industry, and suitable for the use in conveying information to the driver with light using the windshield glass.

1. A light source device for a vehicle, comprising a plurality of light sources, that are arranged in accordance with a curvature of an area on a windshield, to which light from the plurality of light sources is emitted, wherein:
the light source device is installed in the instrument panel at such a position that the light source device faces a driver; and
the light source device is shaped such that a length of the light source device in a vehicle-longitudinal direction increases from a center of the light source device in a vehicle-width direction toward an end of the light source device in the vehicle-width direction.

2. A light source device for a vehicle, comprising:
a light source; and
a light emission plate, that is installed such that a light-emitting face of the light emission plate is inclined toward a driver, wherein:
the light source device is installed in the instrument panel at such a position that the light source device faces a driver; and
the light source device is shaped such that a length of the light source device in a vehicle-longitudinal direction increases from a center of the light source device in a vehicle-width direction toward an end of the light source device in the vehicle-width direction.

3. (canceled)
